(19) United States
(12) Patent Application Publication
(10) Pub. No.: US 2024/0176203 A1
(43) Pub. Date: May 30, 2024

(54) DISPLAY PANEL AND DISPLAY APPARATUS

(71) Applicant: Shanghai Tianma Micro-Electronics Co., Ltd., Shanghai (CN)

(72) Inventors: Feng LU, Shanghai (CN); Jujian FU, Shanghai (CN)

(73) Assignee: Shanghai Tianma Micro-Electronics Co., Ltd., Shanghai (CN)

(21) Appl. No.: 18/432,361

(22) Filed: Feb. 5, 2024

(30) Foreign Application Priority Data
Aug. 30, 2023 (CN) 202311110787.2

(51) Int. Cl. G02F 1/167; G02F 1/1676

(52) U.S. Cl. CPC G02F 1/167; G02F 1/1676

(57) ABSTRACT

Provided are a display panel and a display apparatus. In an embodiment, the display panel includes a substrate and a display medium layer over the substrate. In an embodiment, the display medium layer includes: a microstructure; a plurality of charged particles located in the microstructure; a first electrode at least partially located in the microstructure; and a second electrode at least partially located in the microstructure. In an embodiment, the microstructure has a sidewall not parallel to the substrate and a bottom surface. In an embodiment, the first electrode includes a first side portion located on the sidewall and a first extension portion. In an embodiment, the first extension portion is connected to the first side portion and located on part of the bottom surface.

### CROSS-REFERENCE TO RELATED DISCLOSURE

The present disclosure claims priority to Chinese Patent Application No. 202311110787.2, filed on Aug. 30, 2023, the content of which is incorporated herein by reference in its entirety.

### TECHNICAL FIELD

The present disclosure relates to the technical field of displays, and in particular, to a display panel and a display apparatus.

### BACKGROUND

The electrophoretic total-reflection display technology is commonly used in electronic paper products. In the electrophoretic display technology, black electrophoretic particles, white electrophoretic particles, and color electrophoretic particles are filled in a microcapsule to switch a color of reflection light between black and white. Current electronic paper products employ a reflective display, and a transmissive display cannot be achieved.

### SUMMARY

Embodiments of the present disclosure provide a display panel and a display apparatus.

According to an aspect of the present disclosure, a display panel is provided. In an embodiment, the display panel includes: a substrate and a display medium layer located at a side of the substrate. In an embodiment, the display medium layer includes a plurality of microstructures, a plurality of charged particles located in the plurality of microstructures, a plurality of first electrodes, and a plurality of second electrodes. In an embodiment, the microstructure has a sidewall not parallel to substrate and a bottom surface adjacent to a side of substrate. In an embodiment, at least a part of the first electrode and at least a part of the second electrode are located in a corresponding microstructure. In an embodiment, the first electrode includes a first side portion located on the sidewall of the corresponding microstructure and a first extension portion, and the first extension portion is connected to the first side portion and located on part of the bottom surface of the corresponding microstructure.

According to another aspect of the present disclosure, a display apparatus is provided. In an embodiment, the display apparatus includes: a substrate and a sub-pixel. In an embodiment, the sub-pixel includes: a microstructure having a sidewall not parallel to the substrate and a bottom surface; a plurality of charged particles located in the microstructure; a first electrode at least partially located in the microstructure; and a second electrode at least partially located in the microstructure. In an embodiment, the first electrode comprises a first side portion and a first extension portion, the first side portion is located on the sidewall of the microstructure, and the first extension portion is connected to the first side portion and located on part of the bottom surface of the microstructure.

### DRAWINGS

In order to more clearly illustrate technical solutions of embodiments of the present disclosure, the accompanying drawings used in the embodiments are briefly described below. The drawings described below are merely a part of the embodiments of the present disclosure. Based on these drawings, those skilled in the art can obtain other drawings.

FIG. 1 is a schematic diagram of a display panel according to an embodiment of the present disclosure;

FIG. 2 is a schematic cross-sectional view taken along line A-A′ shown in FIG. 1 according to an embodiment of the present disclosure;

FIG. 3 is a schematic diagram of another display panel according to an embodiment of the present disclosure;

FIG. 4 is a schematic diagram of another display panel according to an embodiment of the present disclosure;

FIG. 5 is a schematic diagram of another display panel according to an embodiment of the present disclosure;

FIG. 6 is a schematic diagram of another display panel according to an embodiment of the present disclosure;

FIG. 7 is a schematic diagram of another display panel according to an embodiment of the present disclosure;

FIG. 8 is a schematic cross-sectional view taken along line B-B′ shown in FIG. 7 according to an embodiment of the present disclosure;

FIG. 9 is a schematic diagram of another display panel according to an embodiment of the present disclosure;

FIG. 10 is a schematic diagram of another display panel according to an embodiment of the present disclosure;

FIG. 11 is a schematic diagram of another display panel according to an embodiment of the present disclosure;

FIG. 12 is a schematic diagram of another display panel according to an embodiment of the present disclosure;

FIG. 13 is a schematic diagram of another display panel according to an embodiment of the present disclosure;

FIG. 14 is a schematic diagram of another display panel according to an embodiment of the present disclosure;

FIG. 15 is a schematic diagram of another display panel according to an embodiment of the present disclosure;

FIG. 16 is a schematic cross-sectional view taken along line C-C′ shown in FIG. 15 according to an embodiment of the present disclosure;

FIG. 17 is a schematic diagram of another display panel according to an embodiment of the present disclosure;

FIG. 18 is a schematic diagram of another display panel according to an embodiment of the present disclosure;

FIG. 19 is a schematic diagram of another display panel according to an embodiment of the present disclosure;

FIG. 20 is a schematic diagram of another display panel according to an embodiment of the present disclosure;

FIG. 21 is a schematic diagram of another display panel according to an embodiment of the present disclosure;

FIG. 22 is a schematic cross-sectional view taken along line D-D′ shown in FIG. 21 according to an embodiment of the present disclosure;

FIG. 23 is a schematic diagram of another display panel according to an embodiment of the present disclosure;

FIG. 24 is a schematic diagram of another display panel according to an embodiment of the present disclosure;

FIG. 25 is a schematic diagram of another display panel according to an embodiment of the present disclosure; and

FIG. 26 is a schematic diagram of a display apparatus according to an embodiment of the present disclosure.

### DETAILED DESCRIPTION

To make the objectives, technical solutions, and advantages of the embodiments of the present disclosure clearer, the technical solutions in the embodiments of the present disclosure will be clearly and completely described below with reference to the accompanying drawings in the embodiments of the present disclosure. Apparently, the described embodiments are some rather than all of the embodiments of the present disclosure. All other embodiments obtained by those of ordinary skill in the art based on the embodiments of the present disclosure without creative efforts should fall within the protection scope of the present disclosure.

Terms used in the embodiments of the present disclosure are only for the purpose of describing specific embodiments, and are not intended to limit the present disclosure. Unless otherwise specified in the context, words, such as “a”, “the”, and “this”, in a singular form in the embodiments of the present disclosure and the appended claims include plural forms.

In a related method, electrophoretic particles move to two sides of a microcapsule by increasing a frequency of a driving voltage, achieving transmissive display. However, in the related method, uses upper and lower electrodes are used to drive the electrophoretic particles to move left and right, in other words, a vertical electric field drives the electrophoretic particles to move transversely. As a result, the related method has a low driving efficiency and a long response time, which limits application of the transmissive display technology. The vertical electric field is an electric field that controls the electrophoretic particles to move along a thickness direction of a display panel.

Embodiments of the present disclosure provide a display panel. A microstructure includes a first electrode and a second electrode. The first electrode includes a first side portion and a first extension portion. At least a part of the second electrode is opposite to the first side portion and/or opposite to the first extension portion. The first electrode can cooperate with at least a part of the second electrode to form a transverse electric field to drive a charged particle to move transversely. In this way, the microstructure is in a transmissive state. Moreover, when the microstructure has a fixed size, with the first extension portion in the first electrode, a spacing between the two electrodes that form the transverse electric field is reduced, thereby increasing strength of the transverse electric field. In an early stage of the movement of the charged particle, a stronger transverse electric field is provided to accelerate the movement of the charged particle, thereby improving efficiency of the transverse movement of the charged particle and reducing response time for state switching.

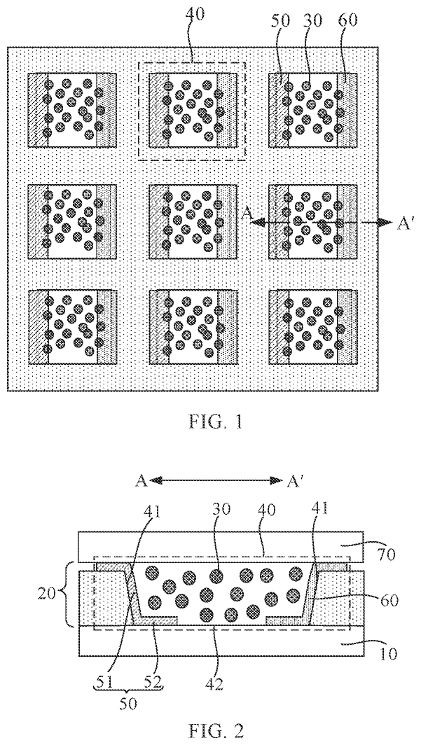

FIG. 1 is a partial schematic diagram of a display panel according to an embodiment of the present disclosure, and FIG. 2 is a schematic cross-sectional view taken along line A-A′ shown in FIG. 1. In some embodiments, as shown in FIG. 1 and FIG. 2, the display panel includes a substrate 10 and a display medium layer 20 located at a side of the substrate 10. The display medium layer 20 includes: a plurality of charged particles 30, a plurality of microstructures 40, a plurality of first electrodes 50, and a plurality of second electrodes 60. Each sub-pixel of the display panel includes one microstructure 40. As shown in FIG. 1, the microstructures 40 are connected to each other. As shown in FIG. 2, the microstructure 40 has a sidewall 41 not parallel to the substrate 10 and a bottom surface 42 adjacent to the substrate 10. For example, the bottom surface 41 is parallel to a plane of the substrate 10. Some charged particles 30 are provided in the microstructure 40. In addition, an electrophoretic solution is provided in the microstructure 40. The first electrode 50 and the second electrode 60 are both at least partially located in the corresponding microstructure 40. The first electrode 50 includes a first side portion 51 located on the sidewall 41 and a first extension portion 52. The first extension portion 52 is connected to the first side portion 51 and located on part of the bottom surface 42. In this embodiment of the present disclosure, at least a part of the second electrode 60 is opposite to the first side portion 51, and/or, at least a part of the second electrode 60 is opposite (or parallel) to the first extension portion 52. FIG. 2 shows an exemplary example that the second electrode 60 includes a part located on the sidewall 41 of the microstructure 40 and another part located on the bottom surface 42 of the microstructure 40. The part of the second electrode 60 located on the sidewall 41 is opposite to the first side portion 51, and the part of the second electrode 60 located on the bottom surface 42 is opposite to the first extension portion 52.

As shown in FIG. 2, the display panel further includes a counter substrate 70 located at a side of the display medium layer 20 away from the substrate 10. The display panel further includes a driver layer (not shown in FIG. 2) disposed between the substrate 10 and the display medium layer 20. The driver layer includes a drive circuit to provide voltage signals to the first electrode and the second electrode.

FIG. 3 is a schematic diagram of another display panel according to an embodiment of the present disclosure. The charged particle 30 in the microstructure 40 in FIG. 3 has a different state from the charged particle 30 in the microstructure 40 in FIG. 2. In FIG. 2, the charged particles 30 are dispersed in the microstructure 40. In FIG. 3, the charged particles 30 are gathered on a side of the sidewall 41 where the first electrode 50 is provided. For example, the charged particles 30 are gathered at the first electrode 50. After voltages are applied to the first electrode 50 and the second electrode 60 respectively, there is a voltage difference between the first electrode 50 and the second electrode 60, forming a transverse electric field. The transverse electric field is an electric field that can drive the charged particle 30 to move along a direction parallel to a plane of the substrate 10. The movement of the charged particle 30 along the direction parallel to the plane of the substrate 10 is referred to as transverse movement. For example, the charged particle 30 is a negatively charged black particle. When the voltage on the first electrode 50 is greater than the voltage on the second electrode 60, the charged particles 30 are gathered at the first electrode 50. In this way, the most region of the microstructure 40 is a transmissive region. As shown by an arrow in FIG. 3, light can be emitted from the substrate 10 to the counter substrate 70 and exit from the counter substrate 70, in other words, the microstructure 40 is in a transmissive state. In this embodiment, the transverse electric field formed between the first electrode 50 and the second electrode 60 can be used to control the sub-pixel of the display panel to be in the transmissive state. In an application, the microstructure 40 can transmit a color of a backlight on a back side of the display panel, or reflect a color of the substrate 10. In FIG. 2, the charged particles 30 are dispersed in the microstructure 40, and the microstructure 40 is in a non-transmissive state. If the charged particle 30 is the black particle, the microstructure 40 is in a reflective state, and reflects black.

The display panel provided in embodiments of the present disclosure includes a plurality of microstructures 40. One sub-pixel corresponds to one microstructure 40. At least a part of the first electrode 50 is located in the microstructure 40. The first electrode 50 includes the first side portion located 51 on the sidewall 41 of the microstructure 40, and the first extension portion 52 located on the bottom surface 42 of the microstructure 40. At least a part of the second electrode 60 is located in the microstructure 40. At least a part of the second electrode 60 is opposite to the first side portion 51, and/or, at least a part of the second electrode 60 is parallel to the first extension portion 52. The first electrode 50 and the second electrode 60 can cooperate with each other to form the transverse electric field to drive the charged particle 30 to move transversely. In this way, the microstructure 40 is in the transmissive state. The display panel provided in embodiments of the present disclosure can achieve transmissive display, and can switch between the transmissive display and the non-transmissive display. Moreover, when the microstructure 40 has a fixed size, the first extension portion 52 in the first electrode 50 can also reduce a spacing between the two electrodes that form the transverse electric field, thereby increasing strength of the transverse electric field. In an early stage of the movement of the charged particle 30, a stronger transverse electric field can accelerate the movement of the charged particle 30, thereby improving efficiency of the transverse movement of the charged particle 30, reducing response time for state switching, and improving user experience.

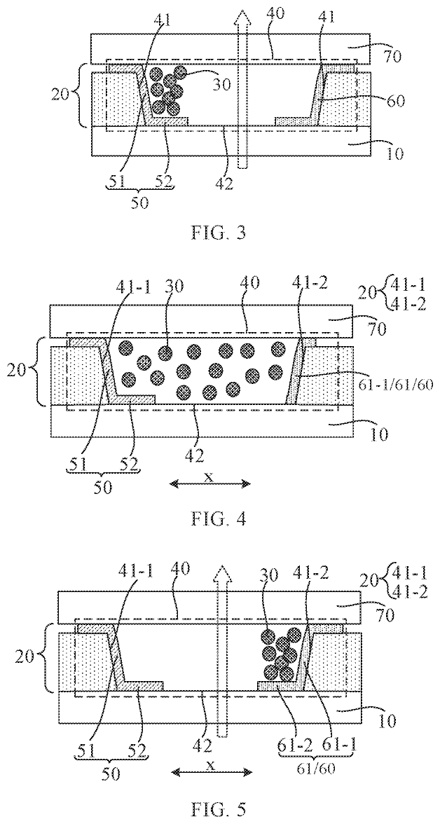

FIG. 4 is a schematic diagram of another display panel according to an embodiment of the present disclosure. As shown in FIG. 4, the sidewall 41 includes a first sidewall 41-1 and a second sidewall 41-2 that are opposite to each other along a first direction x. The first direction x is parallel to the plane of the substrate 10. The first side portion 51 is located on the first sidewall 41-1. The second electrode 60 includes a first sub-electrode 61, the first sub-electrode 61 includes a second side portion 61-1, and the second side portion 61-1 is located on the second sidewall 41-2. In this embodiment, the second side portion 61-1 of the first sub-electrode 61 is opposite to the first side portion 51 of the first electrode 50, in other words, the second electrode 60 is opposite to the first side portion 51 of the first electrode 50. Voltages are applied to the first electrode 50 and the first sub-electrode 61 respectively to form a voltage difference between the first electrode 50 and the first sub-electrode 61. In this way, an electric field that drives the charged particles 30 to move transversely can be formed. The first extension portion 52 extends to the bottom surface 42. Therefore, the first extension portion 52 reduces a spacing between the first electrode 50 and the first sub-electrode 61 in the first direction x, thereby increasing strength of the transverse electric field formed by the first electrode 50 and the first sub-electrode 61. In the early stage of the movement of the charged particle 30, the stronger transverse electric field can accelerate the movement of the charged particle 30, thereby improving the efficiency of the transverse movement of the charged particle 30, reducing the response time for the state switching, and improving the user experience.

In some embodiments, the first sub-electrode 61 further includes a second extension portion. FIG. 5 is a schematic diagram of another display panel. As shown in FIG. 5, the first sub-electrode 61 further includes a second extension portion 61-2 connected to the second side portion 61-1 and located on part of the bottom surface 42. In this embodiment, the second side portion 61-1 of the first sub-electrode 61 is opposite to the first side portion 51 of the first electrode 50, and the second extension portion 61-2 is opposite to the first extension portion 52. Optionally, the second extension portion 61-2 and the first extension portion 52 are parallel to each other on the bottom surface 42. In other words, the second side portion 61-1 of the second electrode 60 is opposite to the first side portion 51 of the first electrode 50, and the second extension portion 61-2 of the second electrode 60 is opposite to the first extension portion 52 of the first electrode 50. In this embodiment, the first electrode 50 and the first sub-electrode 61 can form the electric field that drives the charged particle 30 to move transversely. In addition, the first extension portion 52 and the second extension portion 61-2 reduce the spacing between the first electrode 50 and the first sub-electrode 61 in the first direction x. In this way, the strength of the transverse electric field formed by the first electrode 50 and the first sub-electrode 61 can be further increased, thereby improving the efficiency of the transverse movement of the charged particle 30, reducing switching response time to the transmissive state, and improving the user experience.

In the display panel provided in embodiments of the present disclosure, each sub-pixel includes one microstructure 40. A working mode of the sub-pixel includes a first mode. FIG. 5 schematically shows a state of the charged particles 30 in the microstructure 40 in the first mode. In the first mode, the voltage of the first electrode 50 is not equal to the voltage of the first sub-electrode 61. In the example embodiment shown in FIG. 5, the charged particle 30 is the negatively charged black particle. The voltage of the first electrode 50 is less than the voltage of the first sub-electrode 61, and the charged particles 30 move to and are gathered at the second side portion 61-1. In this way, the most region of the microstructure 40 is the transmissive region. The sub-pixel is in the transmissive state in the first mode, and the light can be emitted from the substrate 10 to the counter substrate 70. In the first mode, the sub-pixel can transmit the color of the backlight on the back side of the display panel, or reflect the color of the substrate 10 in the display panel.

In another embodiment, in the first mode, the voltage of the first electrode 50 is greater than the voltage of the first sub-electrode 61, and the charged particle 30 is the negatively charged black particle. In this case, the charged particles 30 move to and are gathered at the first side portion 51.

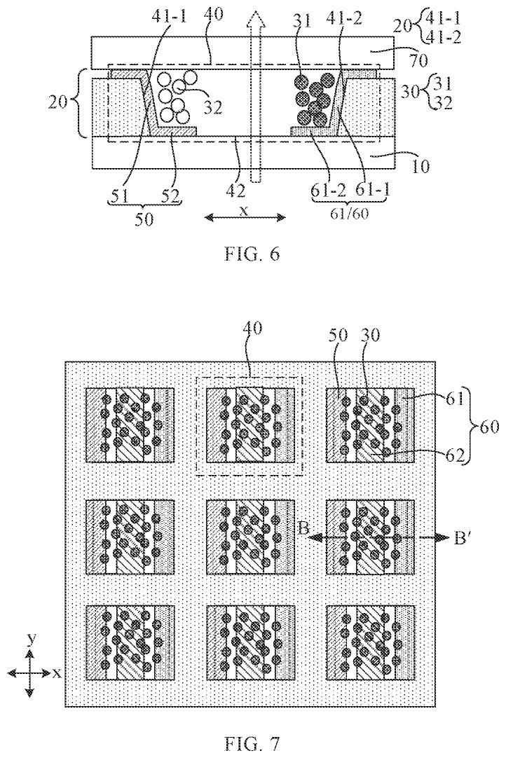

In the example embodiment shown in FIG. 5, the charged particle 30 is the black particle. In some other embodiments, the charged particles 30 include black particles and white particles. FIG. 6 is a schematic diagram of another display panel according to an embodiment of the present disclosure. FIG. 6 schematically shows a state of the charged particles 30 in the microstructure 40 in the first mode. As shown in FIG. 6, the charged particles 30 include the negatively charged black particles 31 and positively charged white particles 32. In the first mode, the voltage of the first electrode 50 is less than the voltage of the first sub-electrode 61, the black particles 31 move to and are gathered at the second side portion 61-1, and the white particles 32 move to and are gathered at the first side portion 51.

FIG. 7 is a schematic diagram of another display panel according to an embodiment of the present disclosure, and FIG. 8 is a schematic cross-sectional view taken along line B-B′ in FIG. 7. With reference to FIG. 7 and FIG. 8, the second electrode 60 includes a first sub-electrode 61 and a second sub-electrode 62. The first electrode 50 and the first sub-electrode 61 are respectively disposed on two opposite sidewalls 41 in the first direction x. The second sub-electrode 62 is located on a part of the bottom surface 42, and runs through the microstructure 40 along a second direction y. The second direction y intersects the first direction x, and both the first direction x and the second direction y are parallel to the plane of the substrate 10. Optionally, the second sub-electrode 62 is parallel to the first extension portion 52 of the first electrode 50. In this embodiment, the second sub-electrode 62 can be used to form a transverse electric field with the first sub-electrode 61 and form a transverse electric field with the first electrode 50 to drive the charged particles 30 to move transversely. In this way, the microstructure 40 is in the transmissive state, and the efficiency of the transverse movement of the charged particle 30 can be improved, and the response time for the state switching can be reduced.

As shown in FIG. 8, the charged particles 30 are dispersed in the microstructure 40, and the microstructure 40 is in the non-transmissive state. In other words, the sub-pixel is in a reflective display state. When the charged particles 30 are black particles, the sub-pixel reflects the black, in other words, a black pixel of an image is displayed.

FIG. 9 is a schematic diagram of another display panel according to an embodiment of the present disclosure. FIG. 9 schematically shows a state of the charged particle 30 in the microstructure 40 in the first mode using the example in which the charged particle 30 is the negatively charged black particle. As shown in FIG. 9, the working mode of the sub-pixel includes the first mode. In the first mode, the voltage of the first electrode 50 is equal to the voltage of the first sub-electrode 61, and not equal to a voltage of the second sub-electrode 62. Some charged particles 30 move to the first side portion 51, and some charged particles 30 move to the second side portion 61-1. In the first mode, the most region of the microstructure 40 is the transmissive region. The first mode is a transmissive display mode of the sub-pixel, and the light can be emitted from the substrate 10 to the counter substrate 70. In this embodiment, in the first mode, the transverse electric field formed between the second sub-electrode 62 and the first electrode 50 drives the charged particle 30 to move to the first side portion 51, and the transverse electric field formed between the second sub-electrode 62 and the first sub-electrode 61 drives the charged particle 30 to move to the second side portion 61-1. The second sub-electrode 62 is disposed on the bottom surface 42, ensuring that the second sub-electrode 62 forms a strong transverse electric field with the first electrode 50 and forms a strong transverse electric field with the first sub-electrode 61 respectively. Such arrangement can improve the efficiency of the transverse movement of the charged particles 30, reduce the response time for the state switching, and improve the user experience.

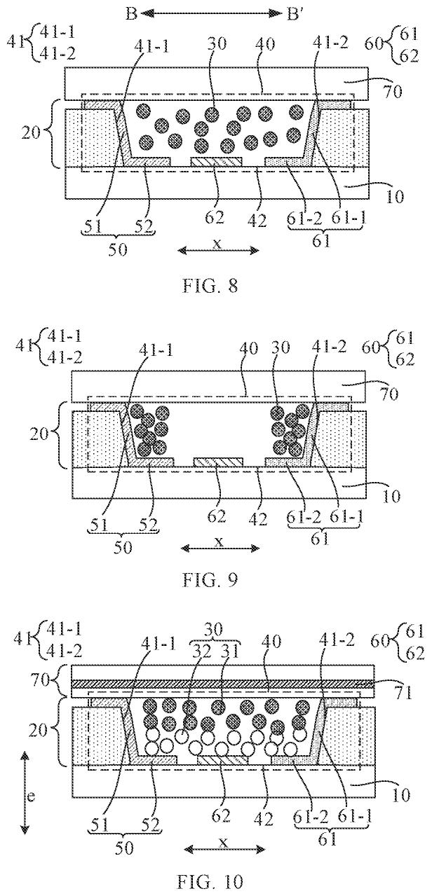

FIG. 10 is a schematic diagram of another display panel according to an embodiment of the present disclosure. As shown in FIG. 10, the counter substrate 70 includes third electrodes 71. In a direction e perpendicular to the plane of the substrate 10, the third electrode 71 least overlaps with the second sub-electrode 62 and the first extension portion 52. In FIG. 10, the first sub-electrode 61 includes the second extension portion 61-2, and the third electrode 71 also overlaps with the second extension portion 61-2. In this embodiment, the third electrode 71 at least overlaps with the second sub-electrode 62 in the microstructure 40. The third electrode 71 and the second sub-electrode 62 can cooperate with each other to form a vertical electric field to drive the charged particle 30 to move along the direction e perpendicular to the plane of the substrate 10. The vertical electric field can be used to control a location of the charged particle 30 in the direction e, achieving the reflective display state of the sub-pixel.

In some embodiments, the first extension portion 52 in the first electrode 50 and the second extension portion 61-2 in the first sub-electrode 61 can also cooperate with the third electrode 71 to form a vertical electric field.

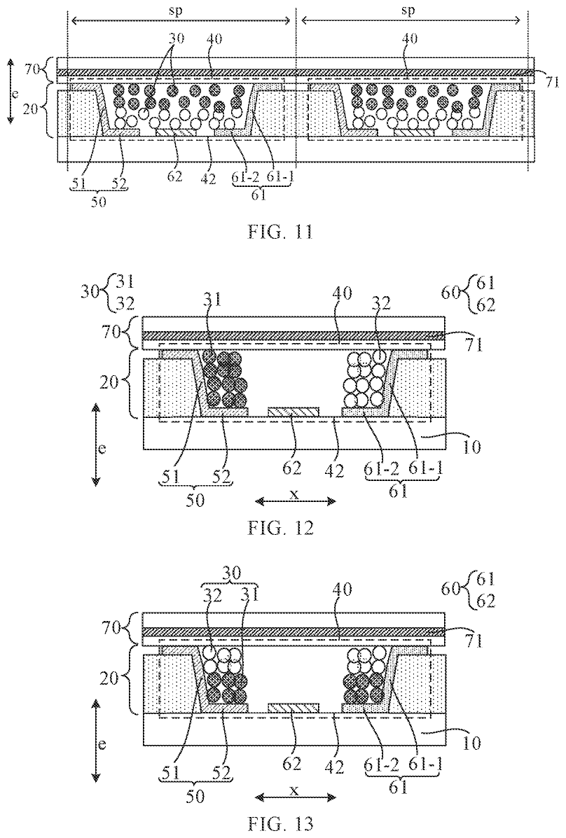

FIG. 11 is a schematic diagram of another display panel according to an embodiment of the present disclosure. As shown in FIG. 11, the display panel includes a plurality of sub-pixels sp. Each sub-pixel sp includes one corresponding microstructure 40 and one corresponding third electrode 71. A plurality of third electrodes 71 of the sub-pixels sp are electrically connected to each other. The third electrode 71 is used as a common electrode. The third electrodes 71 in the sub-pixels sp have an equal voltage. During display, the sub-pixels sp are in different working modes (or display states). For example, when the charged particles 30 in the microstructures 40 need to be controlled to move along the direction e, different voltages can be applied to the second sub-electrodes 62 in different microstructure 40 to respectively control a vertical electric field formed in each sub-pixel sp.

FIG. 12 is a schematic diagram of another display panel according to an embodiment of the present disclosure. The working mode of the sub-pixel includes the first mode. FIG. 12 schematically shows a state of the charged particle 30 in the microstructure 40 in the first mode. In the first mode, the voltage of the second sub-electrode 62 is equal to a voltage of the third electrode 71, and the voltage of the first electrode 50 is not equal to the voltage of the first sub-electrode 61. As shown in FIG. 12, the plurality of charged particles 30 include a plurality of black particles 31 and a plurality of white particles 32. The black particle 31 is a first particle, the white particle 32 is a second particle, and the first particle and the second particle have opposite electrical polarities. In the first mode, the first particle (namely the black particle 31) moves to the first side portion 51, and the second particle (namely the white particle 32) moves to one side of the second side portion 61-1. In the first mode, the most region of the microstructure 40 is the transmissive region, and the light can be emitted from the substrate 10 to the counter substrate 70. The first mode is the transmissive display mode of the sub-pixel, and the sub-pixel is in the transmissive state.

FIG. 13 is a schematic diagram of another display panel according to an embodiment of the present disclosure. In another embodiment, in the first mode, the voltage of the second sub-electrode 62 is not equal to the voltage of the third electrode 71, and the voltage of the first electrode 50 is equal to the voltage of the first sub-electrode 61. As shown in FIG. 13, the plurality of charged particles 30 include a plurality of black particles 31 and a plurality of white particles 32. The black particle 31 is the first particle, the white particle 32 is the second particle, and the first particle and the second particle have opposite electrical polarities. In the first mode, some first particles and some second particles move to the first side portion 51, and some first particles and some second particles move to the second side portion 61-1. In the first mode, the most region of the microstructure 40 is the transmissive region, and light can be emitted from the substrate 10 to the counter substrate 70. The sub-pixel is in the transmissive state in the first mode.

In embodiments in which the display panel includes the first electrode 50, the first sub-electrode 61, the second sub-electrode 62, and the third electrode 71, the present disclosure provides two implementations of the first mode. In one implementation, the voltage difference between the first electrode 50 and the first sub-electrode 61 is used to form the transverse electric field, and the voltage of the second sub-electrode 62 is set to be equal to the voltage of the third electrode 71 to ensure that the charged particle 30 is mainly affected by the transverse electric field and moves in the transverse electric field. In this implementation, the voltage of the second sub-electrode 62 is between the voltage of the first electrode 50 and the voltage of the first sub-electrode 61. In the other implementation, the second sub-electrode 62 forms the transverse electric field with the first electrode 50 and forms the transverse electric field with the first sub-electrode 61 respectively. A weak vertical electric field may be formed when the voltage of the second sub-electrode 62 is not equal to the voltage of the third electrode 71. However, a voltage of each electrode is designed to enable the charged particle 30 to be mainly affected by the transverse electric field and move according to the transverse electric field.

In some embodiments, the plurality of charged particles 30 include a plurality of third particles and a plurality of fourth particles. The third particle and the fourth particle have different colors. The working mode of the sub-pixel includes a second mode. In the second mode, the voltage of the first electrode 50, the voltage of the first sub-electrode 61, and the voltage of the second sub-electrode 62 are equal, but are not equal to the voltage of the third electrode 71. The third particles are located at a side of the fourth particles adjacent to the third electrode 71, or at a side of the fourth particles away from the third electrode 71.

An example in which the black particle is the third particle and the white particle is the fourth particle is used. FIG. 10 schematically shows the second mode of the sub-pixel. As shown in FIG. 10, the charged particles 30 include the black particle 31 and the white particle 32. The black particles 31 are located at a side of the white particles 32 adjacent to the third electrode 71. In this mode, the sub-pixel displays black color using reflection light. Alternatively, in the second mode, the white particles 32 are located at a side of the black particles 31 adjacent to the third electrode 71. In this case, the sub-pixel displays white color using the reflection light. The second mode is a reflective display mode of the sub-pixel. In this embodiment of the present disclosure, if at least one of the third particle and the fourth particle is a colored particle, for example, a red or blue particle, the sub-pixel displays a color of the colored particle.

In this embodiment, the third electrode 71 forms a vertical electric field with the first electrode 50, the first sub-electrode 61, and the second sub-electrode 62 to drive the charged particle 30 to move along the direction e. In this way, the reflective display mode is achieved for the display panel. The display panel provided in the embodiments of the present disclosure has both the transmissive display mode and the reflective display mode, and can adapt to various application scenarios.

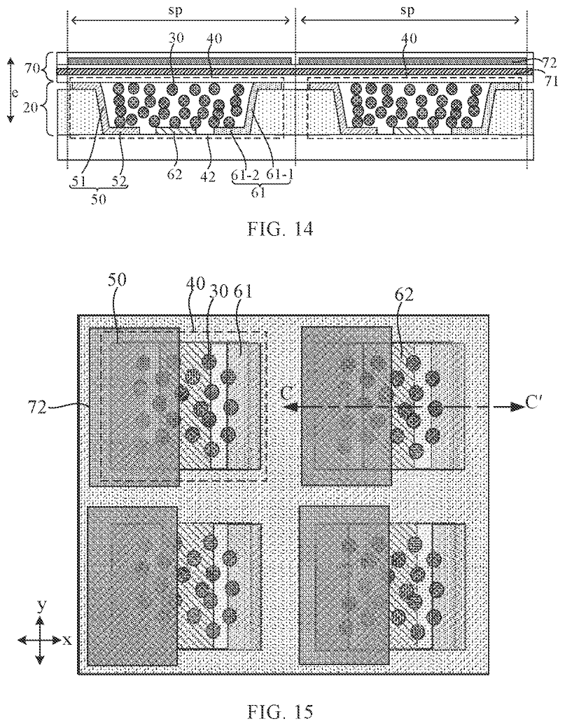

FIG. 14 is a schematic diagram of another display panel according to an embodiment of the present disclosure. As shown in FIG. 14, the counter substrate 70 includes a plurality of color filter units 72, and at least one of the color filter units 72 corresponds to one microstructure 40. In the direction e perpendicular to the plane of the substrate 10, the color filter unit 72 overlaps at least part of the microstructure 40. In this embodiment, with the color filter unit 72, color display of the display panel can be achieved. For example, the sub-pixel sp is in the first mode, the microstructure 40 is in the transmissive state, and light transmits through the microstructure 40, passes the color filter unit 72, and then is emitted. For example, the color filter unit 72 is green. When the transmitted light has a green light component, green light is emitted through the color filter unit 72, and the sub-pixel sp displays green.

In some embodiments, as shown in FIG. 14, each sub-pixel sp includes one microstructure 40 and one color filter unit 72.

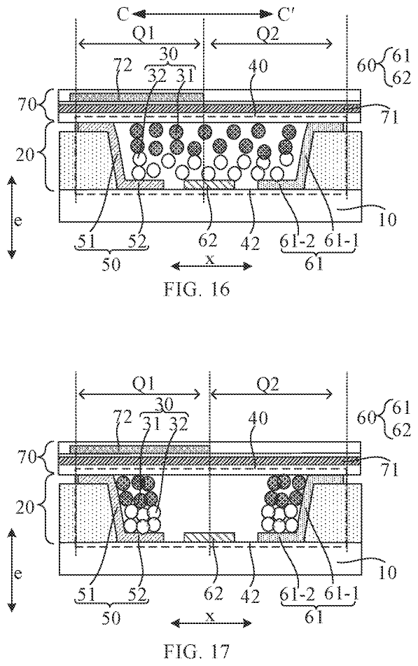

FIG. 15 is a schematic diagram of another display panel according to an embodiment of the present disclosure. FIG. 16 is a schematic cross-sectional view taken along line C-C′ in FIG. 15. With reference to FIG. 15 and FIG. 16, the microstructure 40 is divided into a first region Q1 and a second region Q2 along the first direction x. One of the first electrode 50 and the first sub-electrode 61 is located in the first region Q1, and the other one is located in the second region Q2. FIG. 16 illustrates an example in which the first electrode 50 is located in the first region Q1 and the first sub-electrode 61 is located in the second region Q2. One part of the second sub-electrode 62 is located in the first region Q1, and another part of the second sub-electrode 62 is located in the second region Q2. Along the direction e perpendicular to the plane of the substrate 10, the color filter unit 72 overlaps with the first region Q1, and the color filter unit 72 does not overlap with the second region Q2. In other words, the color filter unit 72 only overlaps part of the microstructure 40. In this embodiment, the first electrode 50, the first sub-electrode 61, the second sub-electrode 62, and the third electrode 71 cooperate with each other to form the electric fields. In this way, the microstructure 40 is in one of the transmissive state, the reflective state, or a state that half of the microstructure 40 is in the transmissive state and half of the microstructure 40 is in the reflective state. The microstructure 40 having different states can cooperate with the color filter unit 72 above the microstructure 40 to achieve a plurality working modes of the sub-pixel, thereby improving display diversity. For example, if the first region Q1 overlapped by the color filter unit 72 is in the transmissive state, and the second region Q2 is in the reflective state, the sub-pixel works in a low-transmittance wide-color-gamut transmissive state. For example, if the first region Q1 overlapped by the color filter unit 72 is in the reflective state, and the second region Q2 is also in the reflective state, the sub-pixel works in a high-reflectivity narrow-color-gamut reflective state.

In some embodiments, the working mode of the sub-pixel includes the first mode. In the first mode, the voltage of the first electrode 50 is equal to the voltage of the first sub-electrode 61, and not equal to the voltage of the third electrode 71, and the voltage of the second sub-electrode 62 is equal to the voltage of the third electrode 71. FIG. 17 is a schematic diagram of another display panel according to an embodiment of the present disclosure. FIG. 17 schematically shows a state of the charged particles 30 in the microstructure 40 in the first mode. As shown in FIG. 17, some charged particles 30 move to the first side portion 51, and some charged particles 30 move to the second side portion 61-1. In this mode, both the first region Q1 and the second region Q2 of the microstructure 40 are in the transmissive state. In the first region Q1, light passes through the first region Q1, and then filtered by the color filter unit 72, and then exits. Light passing through the second region Q2 is not filtered by the color filter unit 72. In this mode, the sub-pixel can display a color of the color filter unit 72. For example, if the color filter unit 72 is a green filter, the sub-pixel displays the green. In addition, since the second region Q2 does not overlap with the color filter unit 72, when white light passes through the second region Q2, the green light of the sub-pixel is mixed with a white light component, resulting in impure green light. As a result, a color gamut displayed by the sub-pixel becomes narrow. Therefore, the first mode of the sub-pixel in this embodiment is a high-transmittance narrow-color-gamut transmissive state.

An example in which the plurality of charged particles 30 include a plurality of black particles 31 and a plurality of white particles 32 is used. The black particle 31 is negatively charged, and the white particle 32 is positively charged. In the first mode, the voltage of the first electrode 50 is set to be equal to the voltage of the first sub-electrode 61 and less than the voltage of the third electrode 71, and the voltage of the second sub-electrode 62 is set to be equal to the voltage of the third electrode 71. In this way, both the first region Q1 and the second region Q2 are in the transmissive state. In addition, on both the first side portion 51 and the second side portion 61-1, the black particle 31 is located at the side of the white particle 32 adjacent to the third electrode 71.

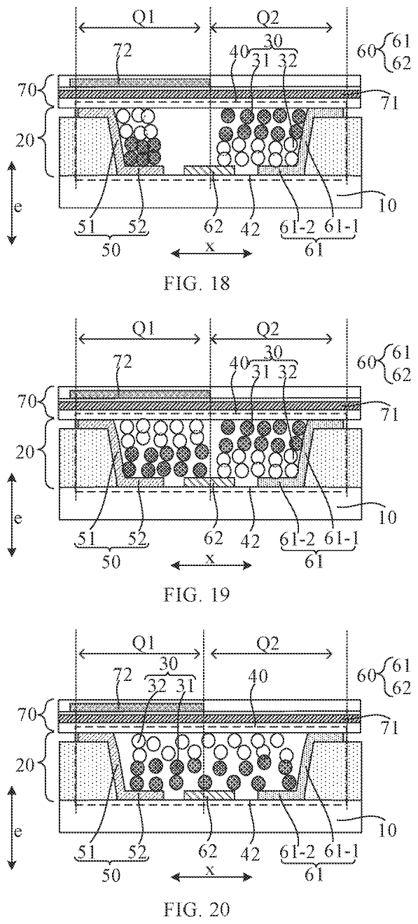

In some embodiments, the working mode of the sub-pixel includes a third mode. In the third mode, the voltage of the first sub-electrode 61 is equal to the voltage of the second sub-electrode 62, and not equal to the voltage of the third electrode 71, and the voltage of the first electrode 50 is neither equal to the voltage of the second sub-electrode 62 nor equal to the voltage of the third electrode 71. FIG. 18 is a schematic diagram of another display panel according to an embodiment of the present disclosure. FIG. 18 schematically shows a state of the charged particles 30 in the microstructure 40 in the third mode. As shown in FIG. 18, the plurality of charged particles 30 include a plurality of black particles 31 and a plurality of white particles 32. The black particle 31 and the white particle 32 have opposite electrical polarities. The first electrode 50 is located in the first region Q1 and the first sub-electrode 61 is located in the second region Q2. In the first region Q1, multiple black particles 31 and multiple white particles 32 are both located at the first side portion 51. In the second region Q2, multiple black particles 31 are located at a side of multiple white particles 32 adjacent to the third electrode 71. The first region Q1 of the microstructure 40 is in the transmissive state, while the second region Q2 is in the reflective state and reflects black. In the first region Q1, the light passes through the first region Q1 and then is filtered by the color filter unit 72. The second region Q2 reflects black. In this mode, the sub-pixel can display the color of the color filter unit 72. For example, if the color filter unit 72 is the green filter unit, the sub-pixel displays green. In addition, since the second region Q2 reflects black and is not transmissive, a light transmission region of the sub-pixel is small, and the light transmission region of the sub-pixel displays pure green. Therefore, the third mode of the sub-pixel in this embodiment is the low-transmittance wide-color-gamut transmissive state.

An example in which the black particle 31 is negatively charged and the white particle 32 is positively charged is used. In the third mode, the voltage of the first sub-electrode 61 is set to be equal to the voltage of the second sub-electrode 62 and less than the voltage of the third electrode 71, and the voltage of the first electrode 50 is set to be greater than the voltage of the third electrode 71. In this way, the black particles 31 and the white particles 32 in the first region Q1 are both located at the first side portion 51, while the black particles 31 in the second region Q2 are located at a side of the white particles 32 in the second region Q2 adjacent to the third electrode 71, such that the first region Q1 is in the transmissive state and the second region Q2 is in the reflective state.

In some embodiments, the working mode of the sub-pixel includes a fourth mode. In the fourth mode, the voltage of the first electrode 50, the voltage of the third electrode 71, and the voltage of the first sub-electrode 61 successively increase or decrease, and the voltage of the third electrode 71 is equal to the voltage of the second sub-electrode 62. FIG. 19 is a schematic diagram of another display panel according to an embodiment of the present disclosure. FIG. 19 schematically shows a state of the charged particles 30 in the microstructure 40 in the fourth mode. As shown in FIG. 19, the charged particles 30 include a plurality of black particles 31 and a plurality of white particles 32. The black particle 31 and the white particle 32 have opposite electrical polarities. In the first region Q1, the white particles 32 are located at a side of the black particles 31 adjacent to the third electrode 71. In the second region Q2, the black particles 31 are located at a side of the white particles 32 adjacent to the third electrode 71. Both the first region Q1 and the second region Q2 of the microstructure 40 are in the reflective state. In the first region Q1, reflected light is filtered by the color filter unit 72 and exits. The second region Q2 reflects black. In this mode, the sub-pixel can display the color of the color filter unit 72. For example, if the color filter unit 72 is the green filter unit, the sub-pixel displays green. In addition, since the second region Q2 reflects the black and is not transmissive, a reflection-light-emitting region of the sub-pixel is small, and the sub-pixel displays the pure green. Therefore, the fourth mode of the sub-pixel in this embodiment is a low-reflectivity wide-color-gamut reflective state.

The example in which the black particle 31 is negatively charged and the white particle 32 is positively charged is used. The first electrode 50 is located in the first region Q1 and the first sub-electrode 61 is located in the second region Q2. In the fourth mode, the voltage of the first electrode 50, the voltage of the third electrode 71, and the voltage of the first sub-electrode 61 successively decrease, and the voltage of the third electrode 71 is equal to the voltage of the second sub-electrode 62. In this way, the white particles 32 in the first region Q1 are located at the side of the black particles 31 in the first region Q1 adjacent to the third electrode 71. The black particles 31 in the second region Q2 are located at the side of the white particles 32 in the second region Q2 adjacent to the third electrode 71. The first region Q1 reflects white, and green light is emitted after the white light passes through the green filter unit, such that green is displayed in the first region Q1. The second region Q2 reflects black, such that the sub-pixel displays green.

It should be noted that in embodiments of the present disclosure, the term “reflecting white” is understood as reflecting white light, and the term “reflecting black” is understood as substantially no light is reflected and the human eyes sense a black color. The terms “reflecting white” and “reflecting black” are simplified descriptions.

In some embodiments, the working mode of the sub-pixel includes a fifth mode. In the fifth mode, the voltage of the first electrode 50, the voltage of the first sub-electrode 61, and the voltage of the second sub-electrode 62 are equal, but are not equal to the voltage of the third electrode 71. FIG. 20 is a schematic diagram of another display panel according to an embodiment of the present disclosure. FIG. 20 schematically shows a state of the charged particles 30 in the microstructure 40 in the fifth mode. As shown in FIG. 20, the charged particles 30 include a plurality of black particles 31 and a plurality of white particles 32. The black particle 31 and the white particle 32 have opposite electrical polarities. The black particles 31 are located at a side of the white particles 32 away from the third electrode 71. Both the first region Q1 and the second region Q2 of the microstructure 40 are in the reflective state, and reflect white. In the first region Q1, the reflected light is filtered by the color filter unit 72 and then exits. For example, if the color filter unit 72 is the green filter unit, the sub-pixel displays green. In addition, since the second region Q2 reflects the white light, the green displayed by the sub-pixel is mixed with the white light component, resulting in the impure green light. As a result, the color gamut displayed by the sub-pixel becomes narrow. Therefore, the fifth mode of the sub-pixel in this embodiment is the high-reflectivity narrow-color-gamut reflective state.

The example in which the black particle 31 is negatively charged and the white particle 32 is positively charged is used. The first electrode 50 is located in the first region Q1 and the first sub-electrode 61 is located in the second region Q2. The voltage of the first electrode 50, the voltage of the first sub-electrode 61, and the voltage of the second sub-electrode 62 are equal, and are greater than the voltage of the third electrode 71. In this way, the black particles 31 are located at the side of the white particles 32 away from the third electrode 71, such that both the first region Q1 and the second region Q2 are in the reflective state.

In another embodiment, FIG. 16 schematically shows another state of the charged particles 30 in the microstructure 40 in the fifth mode. When the black particle 31 is negatively charged and the white particle 32 is positively charged, the voltage of the first electrode 50, the voltage of the first sub-electrode 61, and the voltage of the second sub-electrode 62 are equal, and are less than the voltage of the third electrode 71. In this case, the black particles 31 are located at the side of the white particles 32 adjacent to the third electrode 71. Both the first region Q1 and the second region Q2 of the microstructure 40 are in the reflective state, and reflect black light. In this embodiment, the fifth mode of the sub-pixel is a black state.

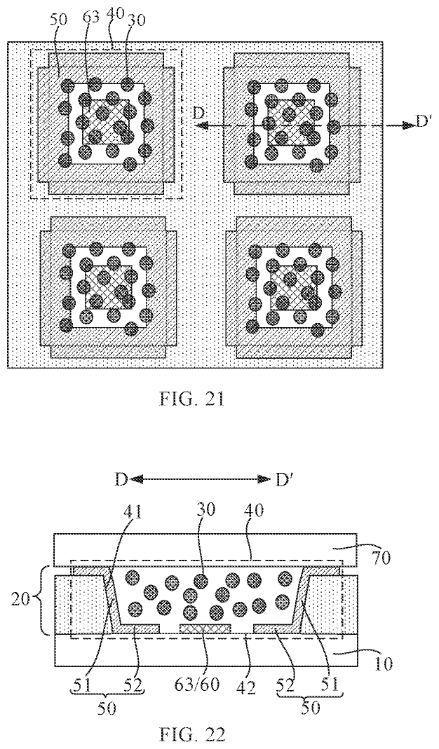

FIG. 21 is a schematic diagram of another display panel according to an embodiment of the present disclosure, and FIG. 22 is a schematic cross-sectional view taken along line D-D′ in FIG. 21. With reference to FIG. 21 and FIG. 22, the second electrode 60 includes a third sub-electrode 63. The third sub-electrode 63 is located on part of the bottom surface 42 and overlaps with a central region of the bottom surface 42. In a top view, the sidewall 41 of the microstructure 40 is circular (for example a rectangular ring) and surrounds the bottom surface 42. The first side portion 51 is located on the circular sidewall 41 and is circular (for example a rectangular ring). The first extension portion 52 is connected to the circular first side portion 51. It can be regarded that the third sub-electrode 63 and the circular first extension portion 52 are disposed opposite to each other. In this embodiment, the first electrode 50 and the third sub-electrode 63 can cooperate with each other to form a transverse electric field to drive the charged particle 30 to move transversely. In this way, the microstructure 40 is in the transmissive state, and the display panel can achieve the transmissive display. Moreover, when the microstructure 40 has the fixed size, the first extension portion 52 can also reduce a spacing between the first electrode 50 and the third sub-electrode 63, thereby increasing strength of the transverse electric field. In the early stage of the movement of the charged particle 30, the stronger transverse electric field can accelerate the movement of the charged particle 30, thereby improving the efficiency of the transverse movement of the charged particle 30, reducing the response time for the state switching, and improving the user experience.

In some embodiments, each sub-pixel includes one microstructure 40. The working mode of the sub-pixel includes the first mode. In the first mode, the voltage of the first electrode 50 is not equal to a voltage of the third sub-electrode 63. FIG. 23 is a schematic diagram of another display panel according to an embodiment of the present disclosure. FIG. 23 schematically shows a state of the charged particles 30 in the microstructure 40 in the first mode. As shown in FIG. 23, the charged particle 30 moves to the circular first side portion 51, and the most region of the microstructure 40 is the transmissive region. In this embodiment, the first mode of the sub-pixel is the transmissive state. Light/color of the backlight on the back side of the display panel can pass through the sub-pixel, or the color of the substrate 10 can be reflected.

The example in which the charged particle 30 is the negatively charged black particle is used. When the voltage of the first electrode 50 is greater than the voltage of the third sub-electrode 63, the sub-pixel is in the first mode shown in FIG. 23.

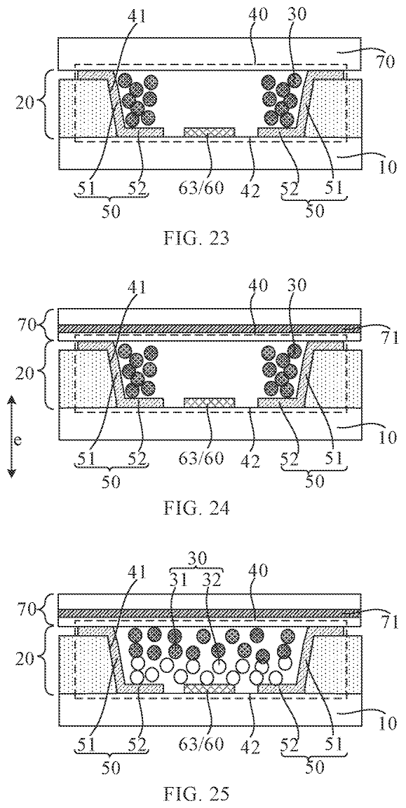

FIG. 24 is a schematic diagram of another display panel according to an embodiment of the present disclosure. As shown in FIG. 24, the counter substrate 70 is located at the side of the display medium layer 20 away from the substrate 10, and includes the third electrodes 71. In the direction e perpendicular to the plane of the substrate 10, the third electrode 71 at least overlaps with the third sub-electrode 63 and the first extension portion 52. In this embodiment, the third electrode 71 at least overlaps with the third sub-electrode 63 in the microstructure 40. The third electrode 71 and the third sub-electrode 63 can cooperate with each other to form a vertical electric field to drive the charged particle 30 to move along the direction e perpendicular to the plane of the substrate 10. The vertical electric field can be used to control the location of the charged particle 30 in the direction e, achieving the reflective display state of the sub-pixel. Optionally, the first extension portion 52 in the first electrode 50 can also cooperate with the third electrode 71 to form a vertical electric field.

In this embodiment of the present disclosure, the working mode of the sub-pixel includes the first mode. FIG. 24 schematically shows a state of the charged particles 30 in the microstructure 40 in the first mode. As shown in FIG. 24, in the first mode, the voltage of the third electrode 71 is equal to the voltage of the third sub-electrode 63, and not equal to the voltage of the first electrode 50. A transverse electric field formed between the third sub-electrode 63 and the first electrode 50 drives the charged particle 30 to move to the circular first side portion 51. The example in which the charged particle 30 is the negatively charged black particle is used. When the voltage of the first electrode 50 is greater than the voltage of the third sub-electrode 63, the sub-pixel is in the first mode shown in FIG. 24. In the first mode, the most region of the microstructure 40 is the transmissive region, and the first mode of the sub-pixel is the transmissive state.

In some other implementations, the working mode of the sub-pixel further includes the second mode. In the second mode, the voltage of the third sub-electrode 63 is equal to the voltage of the first electrode 50, and not equal to the voltage of the third electrode 71. FIG. 25 is a schematic diagram of another display panel according to an embodiment of the present disclosure. FIG. 25 schematically shows a state of the charged particles 30 in the second mode. The example in which the charged particles 30 include the black particles 31 and the white particles 32 is used. The black particle 31 is the third particle, and the white particle 32 is the fourth particle. As shown in FIG. 25, the black particle 31 is negatively charged and the white particle 32 is positively charged. When the voltage of the third sub-electrode 63 is equal to the voltage of the first electrode 50 and less than the voltage of the third electrode 71, the black particles 31 are located at the side of the white particles 32 adjacent to the third electrode 71. In the second mode, the microstructure 40 is in the reflective state, and reflects black, in other words, the sub-pixel displays black.

Alternatively, in the second mode, the voltage of the third sub-electrode 63 is equal to the voltage of the first electrode 50 and greater than the voltage of the third electrode 71. In this case, the white particles 32 are located at a side of the black particles 31 away from the third electrode 71. In the second mode, the microstructure 40 is in the reflective state, and reflects white light, in other words, the sub-pixel displays white.

In addition, on a basis of the display panel provided in the embodiment shown in FIG. 22, the color filter unit can also be disposed in the counter substrate 70. The color filter unit overlaps at least part of the microstructure 40 to achieve color display of the display panel.

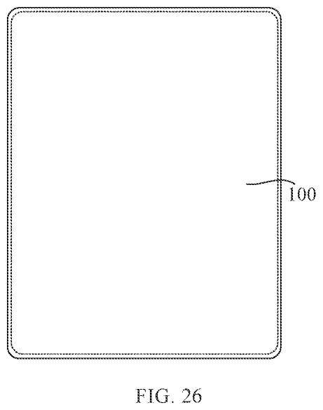

Embodiments of the present disclosure further provide a display apparatus. FIG. 26 is a schematic diagram of a display apparatus according to an embodiment of the present disclosure. As shown in FIG. 26, the display apparatus includes the display panel 100 provided in any embodiment of the present disclosure. The structure of the display panel 100 has been described in the foregoing embodiments, and details are not repeated. The display apparatus provided by the embodiment of the present disclosure may be an electronic product such as a smart tag, a reader, an advertising billboard.

The above descriptions are merely exemplary embodiments of the present disclosure, and are not intended to limit the present disclosure. Any modifications, equivalent replacements, improvements, and the like made within the spirit and principle of the present disclosure shall fall within the protection scope of the present disclosure.

Finally, it should be noted that the foregoing embodiments are merely intended to describe and not to limit the technical solutions of the present disclosure. Although the present disclosure has been described in detail with reference to the foregoing embodiments, persons skilled in the art should understand that they can still make modifications to the technical solutions described in the foregoing embodiments or make equivalent replacements to some or all of the technical features thereof. These modifications or replacements do not make the essence of the corresponding technical solutions deviate from the scope of the technical solutions of the embodiments of the present disclosure.

What is claimed is:

1. A display panel, comprising:
a substrate; and
a display medium layer located over the substrate, wherein the display medium layer comprises:
a plurality of charged particles;
a plurality of microstructures, wherein a microstructure of the plurality of microstructures comprises a sidewall not parallel to the substrate and a bottom surface adjacent to the substrate, and is disposed therein with some of the charged particles;
a plurality of first electrodes; and
a plurality of second electrodes,
wherein a first electrode of the plurality of first electrodes and a second electrode of the plurality of second electrodes are at least partially located in the microstructure, the first electrode comprises a first side portion and a first extension portion, the first side portion is located on the sidewall of the microstructure, and the first extension portion is connected to the first side portion and located on part of the bottom surface of the microstructure.

2. The display panel according to claim 1, wherein the sidewall comprises a first sidewall and a second sidewall that are opposite to each other along a first direction, and the first direction is parallel to a plane of the substrate,
the first side portion is located on the first sidewall, and
the second electrode comprises a first sub-electrode, and the first sub-electrode comprises a second side portion located on the second sidewall.

3. The display panel according to claim 2, wherein the first sub-electrode further comprises a second extension portion connected to the second side portion and located on part of the bottom surface.

4. The display panel according to claim 2 further comprising: a plurality of sub-pixels, wherein the plurality of sub-pixels comprises the plurality of microstructures,
wherein a working mode of the sub-pixel comprises a first mode, and
wherein, in the first mode, a voltage of the first electrode is not equal to a voltage of the first sub-electrode, and the charged particle moves to the first side portion or the second side portion.

5. The display panel according to claim 2, wherein the second electrode further comprises a second sub-electrode that is located on part of the bottom surface of the corresponding microstructure and runs through the corresponding microstructure along a second direction, and the second direction intersects with the first direction and is parallel to the plane of the substrate.

6. The display panel according to claim 5, further comprising: a plurality of sub-pixels, wherein the plurality of sub-pixels comprises the plurality of microstructures,
wherein a working mode of the sub-pixel comprises a first mode, and
wherein, in the first mode, a voltage of the first electrode is equal to a voltage of the first sub-electrode and not equal to a voltage of the second sub-electrode, some of the charged particles in the microstructure move to the first side portion, and some of the charged particles in the microstructure move to the second side portion.

7. The display panel according to claim 5, further comprising a counter substrate located at a side of the display medium layer away from the substrate, wherein the counter substrate comprises third electrodes, and
wherein, in a direction perpendicular to the plane of the substrate, the third electrode at least overlaps with the second sub-electrode and the first extension portion.

8. The display panel according to claim 7, further comprising a plurality of sub-pixels, wherein the plurality of sub-pixels comprises the plurality of microstructures,
wherein a working mode of the sub-pixel comprises a first mode, and
wherein, in the first mode, a voltage of the second sub-electrode is equal to a voltage of the third electrode and a voltage of the first electrode is not equal to a voltage of the first sub-electrode, or a voltage of the second sub-electrode is not equal to a voltage of the third electrode and a voltage of the first electrode is equal to a voltage of the first sub-electrode, and some of the charged particles in the microstructure move to the first side portion, and some of the charged particles in the microstructure move to the second side portion.

9. The display panel according to claim 8, wherein the plurality of charged particles comprise a plurality of first particles and a plurality of second particles, and the plurality of first particles and the plurality of second particles have opposite electrical polarities, and
wherein, in the first mode, some of the first particles and some of the second particles move to the first side portion, and some of the first particles and some of the second particles move to the second side portion.

10. The display panel according to claim 8, wherein the plurality of charged particles comprise a plurality of third particles and a plurality of fourth particles, and the plurality of third particles and the plurality of fourth particles comprise different colors,
wherein the working mode of the sub-pixel further comprises a second mode, and
wherein, in the second mode, the voltage of the first electrode, the voltage of the first sub-electrode, and the voltage of the second sub-electrode are equal, but are not equal to the voltage of the third electrode, and the third particles are located at a side of the fourth particles adjacent to the third electrode, or located at a side of the fourth particles away from the third electrode.

11. The display panel according to claim 7, further comprising a plurality of sub-pixels, wherein the plurality of sub-pixels comprises the plurality of microstructures and the third electrodes,
wherein the third electrodes of the sub-pixels are electrically connected.

12. The display panel according to claim 7, wherein the counter substrate comprises a plurality of color filter units, and at least one of the plurality of color filter units corresponds to the plurality of microstructures, and wherein in the direction perpendicular to the plane of the substrate, the at least one color filter unit overlaps with at least part of the corresponding microstructure.

13. The display panel according to claim 12, wherein the microstructure is divided into a first region and a second region along the first direction, one of the first electrode and the first sub-electrode corresponding to the microstructure is located in the first region, and the other one of the first electrode and the first sub-electrode corresponding to the microstructure is located in the second region, and the second sub-electrode comprises a part located in the first region and another part located in the second region, and
wherein, in the direction perpendicular to the plane of the substrate, the color filter unit overlaps with the first region.

14. The display panel according to claim 13, further comprising a plurality of sub-pixels, and the plurality of sub-pixels comprising the plurality of microstructures and the plurality of color filter units,
wherein a working mode of the sub-pixel comprises a first mode, and
wherein, in the first mode, a voltage of the first electrode is equal to a voltage of the first sub-electrode, and not equal to a voltage of the third electrode, a voltage of the second sub-electrode is equal to the voltage of the third electrode, some of the charged particles in the microstructure move to the first side portion, and some of the charged particles in the microstructure move to the second side portion.

15. The display panel according to claim 13, further comprising a plurality of sub-pixels, wherein the plurality of sub-pixels comprises the plurality of microstructures and the plurality of color filter units,
wherein the plurality of charged particles comprise a plurality of black particles and a plurality of white particles comprising opposite electrical polarities of the plurality of black particles,
wherein the first electrode is located in the first region, and the first sub-electrode is located in the second region,
wherein a working mode of the sub-pixel comprises a third mode, and
wherein, in the third mode, a voltage of the first sub-electrode is equal to a voltage of the second sub-electrode, and not equal to a voltage of the third electrode, a voltage of the first electrode is neither equal to the voltage of the second sub-electrode nor equal to the voltage of the third electrode, the plurality of black particles and the plurality of white particles in the first region are all located on one side of the first side portion, and the plurality of black particles in the second region are located on one side of the plurality of white particles in the second region adjacent to the third electrode.

16. The display panel according to claim 13, further comprising a plurality of sub-pixels, and the plurality of sub-pixels comprising the plurality of microstructures and the plurality of color filter units,
wherein the plurality of charged particles comprise a plurality of black particles and a plurality of white particles having opposite electrical polarities to the plurality of black particles,
wherein a working mode of the sub-pixel comprises a fourth mode, and
wherein, in the fourth mode, a voltage of the first electrode, a voltage of the third electrode, and a voltage of the first sub-electrode successively increase or decrease, the voltage of the third electrode is equal to a voltage of the second sub-electrode, the plurality of white particles in the first region are located on one side of the plurality of black particles in the first region adjacent to the third electrode, and the plurality of black particles in the second region are located on one side of the plurality of white particles in the second region adjacent to the third electrode.

17. The display panel according to claim 13, further comprising a plurality of sub-pixels, and the plurality of sub-pixels comprising the plurality of microstructures and the plurality of color filter units,
wherein the plurality of charged particles comprise a plurality of black particles and a plurality of white particles having opposite electrical polarities,
wherein a working mode of the sub-pixel comprises a fifth mode, and
wherein, in the fifth mode, a voltage of the first electrode, a voltage of the first sub-electrode, and a voltage of the second sub-electrode are equal, but are not equal to a voltage of the third electrode, and the plurality of black particles are located on one side of the plurality of white particles adjacent to the third electrode, or the plurality of black particles are located on one side of the plurality of white particles away from the third electrode.

18. The display panel according to claim 1, wherein the second electrode comprises a third sub-electrode located on part of the bottom surface and overlapping a central region of the bottom surface, and
wherein the sidewall of the microstructure is circular and surrounds the bottom surface, the first side portion is located on the circular sidewall and is circular, and the first extension portion is connected to the circular first side portion.

19. The display panel according to claim 18, further comprising a plurality of sub-pixels, and the plurality of sub-pixels comprising the plurality of microstructures,
wherein a working mode of the sub-pixel comprises a first mode, and
wherein, in the first mode, a voltage of the first electrode is not equal to a voltage of the third sub-electrode, and the charged particles in the microstructure move to the circular first side portion.

20. The display panel according to claim 18, further comprising a counter substrate located at a side of the display medium layer away from the substrate, and the counter substrate comprising third electrodes,
wherein in a direction perpendicular to a plane of the substrate, the third electrode at least overlaps with the third sub-electrode and the first extension portion.

21. The display panel according to claim 20, further comprising a plurality of sub-pixels, and each of the plurality of sub-pixels comprising one of the plurality of microstructures,
wherein a working mode of the sub-pixel comprises a first mode, and
wherein in the first mode, a voltage of the third electrode is equal to a voltage of the third sub-electrode, and not equal to a voltage of the first electrode, and the charged particles in the microstructure move to the circular first side portion.

22. The display panel according to claim 20, further comprising a plurality of sub-pixels, and the plurality of sub-pixels comprising the plurality of microstructures,
wherein the plurality of charged particles comprise a plurality of third particles and a plurality of fourth particles, wherein the plurality of third particles and the plurality of fourth particles have different colors,
wherein a working mode of the sub-pixel comprises a second mode, and
wherein, in the second mode, a voltage of the third sub-electrode is equal to a voltage of the first electrode, and not equal to a voltage of the third electrode, and the plurality of third particles are located at a side of the plurality of fourth particles adjacent to the third electrode, or located at a side of the plurality of fourth particles away from the third electrode.

23. A display apparatus, comprising:
a display panel, wherein the display panel comprises:
a substrate; and
a sub-pixel, and the sub-pixel comprises:
a microstructure comprising a sidewall not parallel to the substrate and a bottom surface;
a plurality of charged particles located in the microstructure;
a first electrode at least partially located in the microstructure; and
a second electrode at least partially located in the microstructure,
wherein the first electrode comprises a first side portion and a first extension portion, the first side portion is located on the sidewall of the microstructure, and the first extension portion is connected to the first side portion and located on part of the bottom surface of the microstructure.
